(19) United States
(12) Patent Application Publication
(10) Pub. No.: US 2013/0255449 A1
(43) Pub. Date: Oct. 3, 2013

(54) HAND TOOL

(71) Applicant: Man-Chi Chang, Taichung (TW)

(72) Inventor: Man-Chi Chang, Taichung (TW)

(21) Appl. No.: 13/434,816

(22) Filed: Mar. 29, 2012

(51) Int. Cl. B25B 23/16; B25G 1/00

(52) U.S. Cl. 81/177.1

(57) ABSTRACT

A hand tool includes a body, two control units and a connection member. The body is connected with another tool. The two control units are respectively connected to the body and each control unit includes a control member, a sleeve, multiple engaging members, a connection ring and a resilient member. The connection member is mounted to the body and located between the two control units.

### FIELD OF THE INVENTION

The present invention relates to an elongate hand tool, and more particularly, to an elongate hand tool connectable to the other hand tool.

### BACKGROUND OF THE INVENTION

The conventional elongate hand tool as shown in FIG. 10 comprises a T-shaped body 40 and a tool bit such as a driver bit is connected to one end of the body to tighten or loosen a screw. The user has to hold the body 40 by one hand and the other hand hold the outer surface of the body 40 when rotating the body 40. However, when rotating the body 40, friction is generated between the hand and the body 40 so that the rotational action is restricted.

The present invention intends to provide a hand tool that improves the drawback of the conventional hand tool.

### SUMMARY OF THE INVENTION

The present invention relates to a hand tool and comprises a body, two control units and a connection member. The body is connected with another tool. The two control units are respectively connected to the body and each control unit includes a control member, a sleeve, multiple engaging members, a connection ring and a resilient member. The connection member is mounted to the body and located between the two control units.

The primary object of the present invention is to provide a hand too which is easily operated.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the hand tool of the present invention;

FIG. 2 is a front view of the hand tool of the present invention;

FIG. 3 is a cross-sectional view, taken along line A-A of FIG. 2;

FIG. 4 is a perspective view to show the hand tool of the present invention;

FIG. 5 is a top view of the hand tool of the present invention;

FIG. 6 is a cross-sectional view, taken along line B-B of FIG. 5;

FIG. 7 is a cross-sectional view to show the action to the hand tool in FIG. 6;

FIG. 8 is a perspective view to show the second embodiment of the hand tool of the present invention;

FIG. 9 is a perspective view to show the third embodiment of the hand tool of the present invention, and

FIG. 10 shows the conventional hand tool.

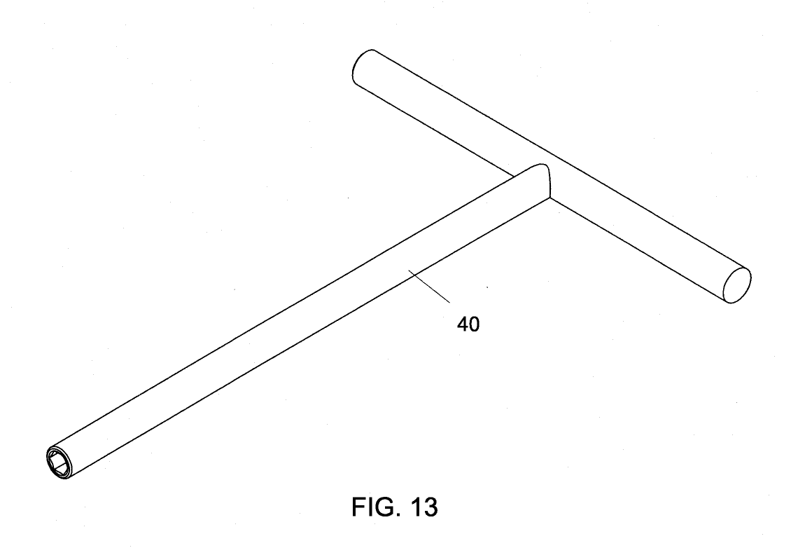

### DETAILED DESCRIPTION OF THE PREFERRED EMBODIMENT

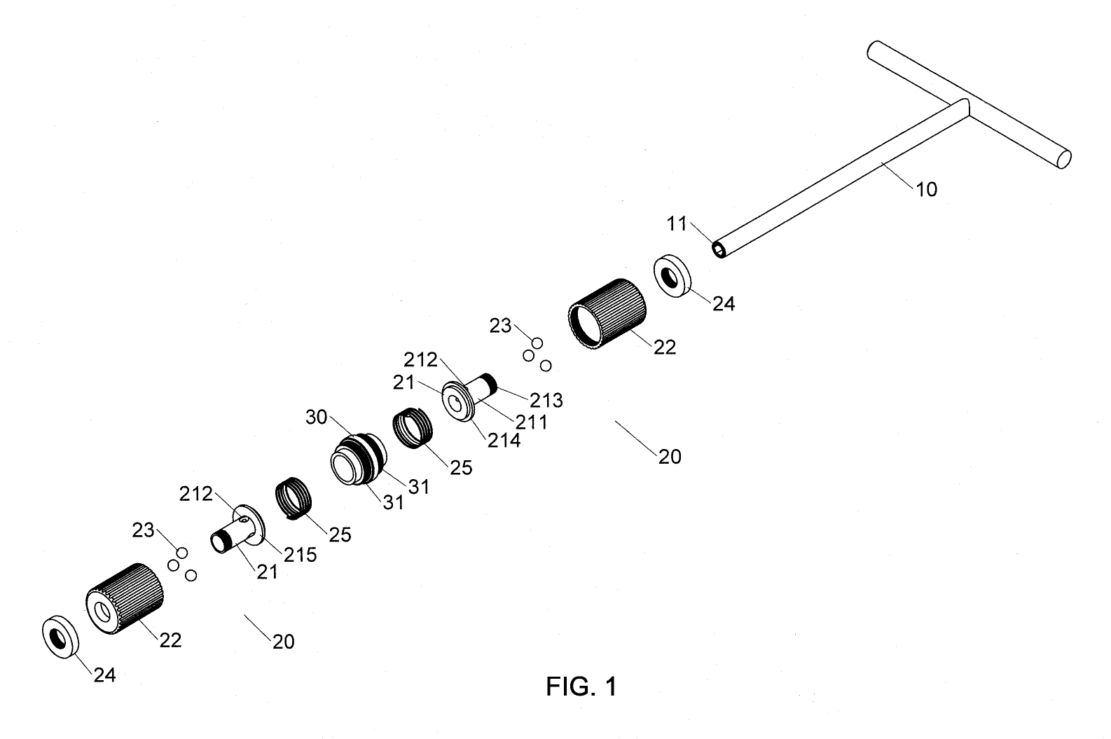

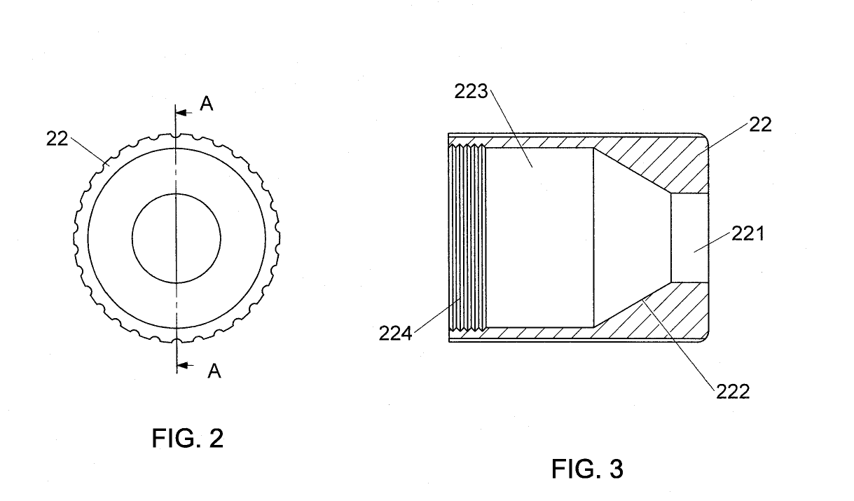

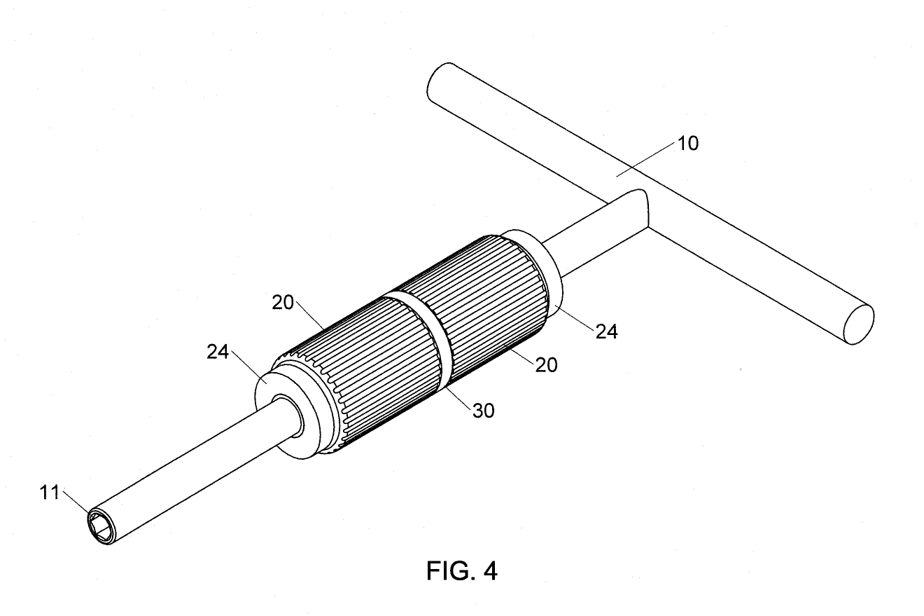

Referring to FIGS. 1 to 3, the hand tool of the present invention comprises a body 10, two control units 20 and a connection member 30.

The body 10 is a T-shaped body and has an engaging portion 11 defined in one end thereof, the engaging portion 11 is a polygonal recess so as to be engaged with a driver bit.

The two control units 20 are respectively connected to the body 10 and each control unit 20 has a control member 21, a sleeve 22, multiple engaging members 23, a connection ring 24 and a resilient member 25. The control member 21 is a tubular member and rotatably mounted to the body 10. A tubular control portion 211 extends from the first end of the control member 21 and has three holes 212 defined annularly therein. Each hole 212 has a cone-shaped inner periphery and expands outward. The control portion 211 has a first connection portion 213 at one end thereof and the first connection portion 213 has outer threads or other connectable design. The control member 21 has a first end portion 214 located at the second end thereof so that a flange 215 is formed and extends between the control member 21 and the control portion 211 due to the difference of diameters. The flange 215 is located close to the holes 212. The sleeve 22 is a tubular member and has a through bore 221, a cone-shaped passage 222, a reception portion 223 and a second connection portion 224. The through bore 221 is defined in the first end of the sleeve 22, and the cone-shaped passage 222 communicates between the through bore 221 and the reception portion 223. The reception portion 223 is a circular recess and the control member 21 is received in the reception portion 223. The cone-shaped passage 222 faces the flange 215. The control portion 211 extends through the through bore 221. The first connection portion 213 extends beyond the sleeve 22. The smallest inner diameter of the cone-shaped passage 222 is the same as the inner diameter of the through bore 221. The largest inner diameter of the cone-shaped passage 222 is the same as the inner diameter of the reception portion 223. The second connection portion 224 is located remote from the through bore 221 and engaged with the second end of the sleeve 22. The second connection portion 224 has inner threads. Each engaging member 23 is a bead and the number of the engaging members 23 is the same as that of the holes 212. The engaging members 23 are in contact between the flanges 215 and the cone-shaped passage 222. Each engaging member 23 is received in one of the holes 212 corresponding thereto. The smallest inner diameter of the holes 212 is less than the diameter of the engaging members 23. The connection ring 24 has inner threads and is mounted to the sleeve 22 and threadedly connected to the first connection portion 213. A gap is defined between the sleeve 22 and the connection ring 24. The resilient member 25 is located in the reception portion 223. The resilient member 25 has one end mounted to the first end portion 214 and contacts against the control member 21.

The connection member 30 is located between the two control units 20 and mounted to the body 10. The connection member 30 is a tubular member and has two third connection portions 31 respectively located on two ends thereof and each of the two third connection portions 31 has outer threads. The two third connection portions 31 are connected to the second connection portions 224 to connect the two control units 20 to the connection member 30. The connection member 30 has two second end portions on two ends thereof and the diameter of each second end portion is smaller than that of the third connection portion 31. A shoulder portion is defined between the second end portion and the third connection portion 31. The resilient member 25 has the other end contacting against the second end portion.

The resilient member 25 of each control unit 20 is biased against the first end portion 214 of the control member 21 and the connection member 30. The engaging member 23 is restricted between the cone-shaped passage 222 of the sleeve 22 and the flange 215 and received in the hole 212. The engaging member 23 contacts against the outer surface of the body 10. In other words, the body 10 is clamped by multiple engaging members 23 so that the body 10, the two control units 20 and the connection member 30 are fixed.

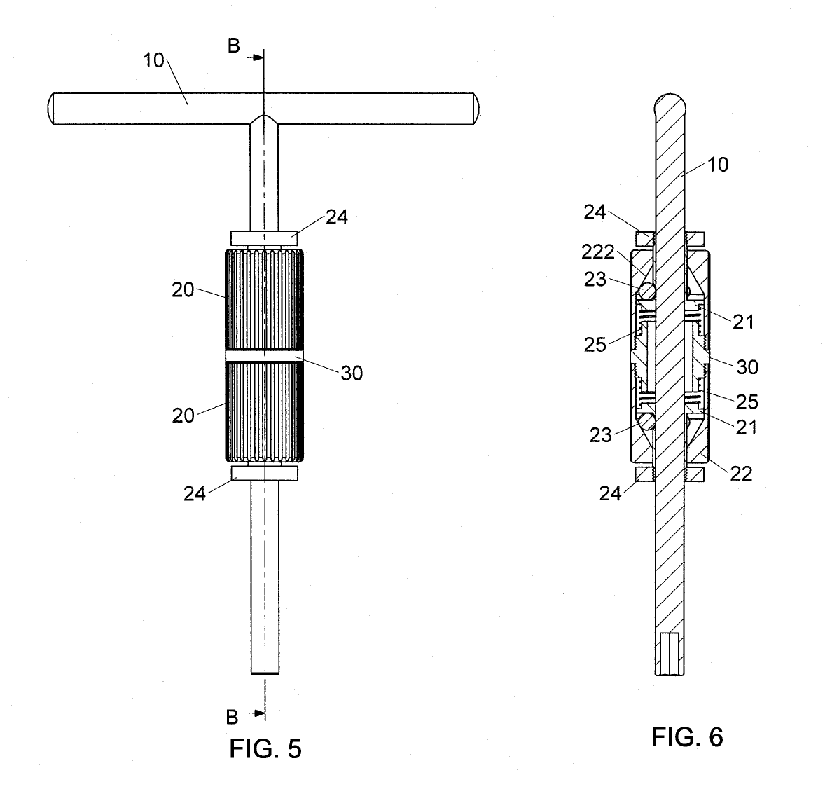

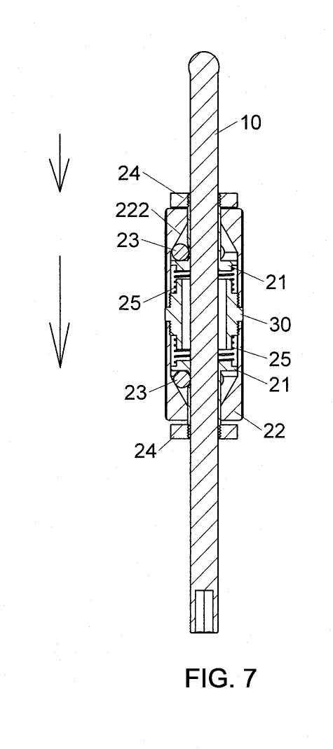

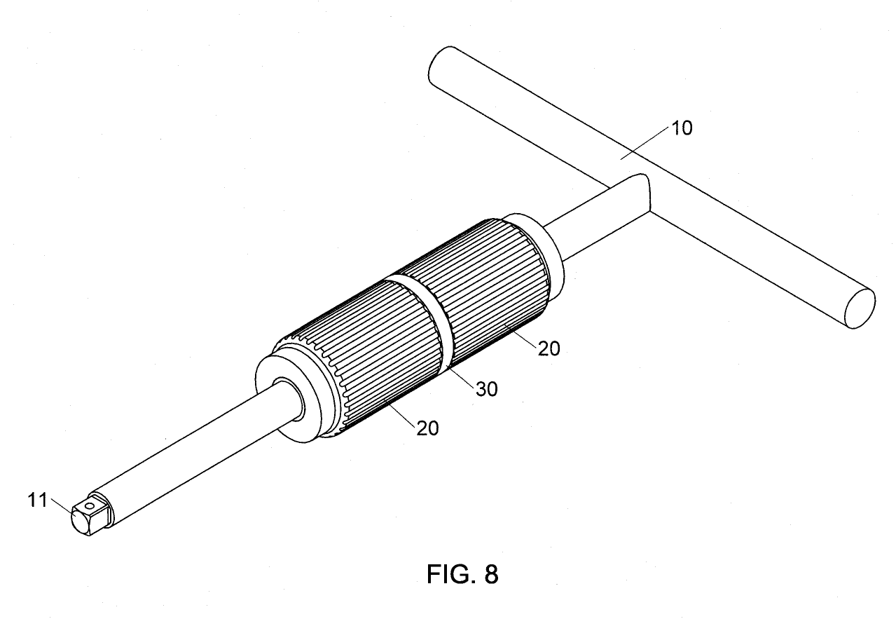

As shown in FIGS. 4 to 6, when assembling, the engaging members 23 are received in the holes 212 of the control members 21, the first connection portions 213 extend through the through bores 221 of the sleeve 22 and are connected to the connection rings 24. The control member 21 and the resilient member 25 are located in the sleeve 22, the two sleeves 22 are mounted to the two ends of the connection member 30. The resilient member 25 is located between the control member 21 and the connection member 30. The body 10 extends through the two control units 20 and the connection member 30. Each engaging member 23 is in contact between the cone-shaped passage 222 of the sleeve 22 and the flange 215 of the control member 21. The multiple engaging members 23 are compressed by the cone-shaped passage 222 and the flange 215 to clamp the outer surface of the body 10 which is then not movable between the two control units 20.

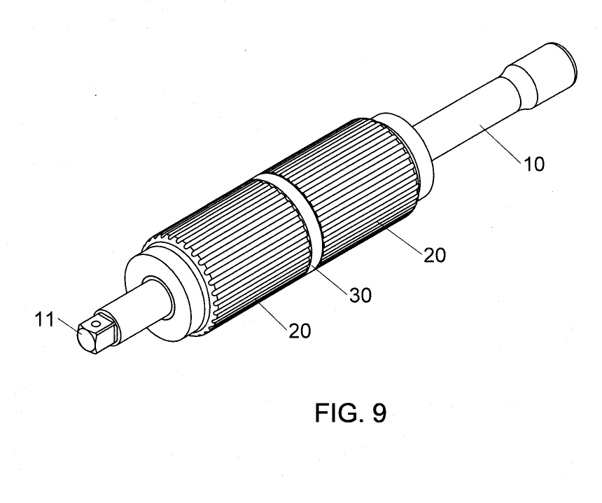

As shown in FIG. 7, pressing the connection ring 24 of one of the two control units 20, the connection ring 24 and the control member 21 move a distance relative to the sleeve 22, the resilient member 25 is compressed by the movement of the control member 21 and the flange 215 is moved away from the cone-shaped passage 222. The engaging members 23 are not restricted by the cone-shaped passage 222 and do not compress the body 10. The two control units 20 are moved along the direction that the connection ring 24 is pressed to adjust the clamping position. The engaging members 23 of the other control unit 20 are compressed by the cone-shaped passage 222 and cannot move and adjust the clamping position. When releasing the connection ring 24, the engaging member 23 in the holes 212 are compressed by the cone-shaped passage 222 and the flange 215, and clamp the outer surface of the body 10 to set the two control units 20 to be positioned on the body 10. When pressing the connection ring 24 of the other control unit 20, the two control units 20 are moved along the direction that the connection ring 24 is pressed to adjust the clamping position. The two control units 20 are not able to move in opposite direction and to adjust the clamping position. That is to say, the body 10 is still controlled by one of the two control units 20 and cannot move in the opposite direction. When compressing the two connection rings 24 of the two control units 20, all of the engaging members 23 are separated from the outer surface of the body 10 and the two control units 20 are freely movable along the body 10 to adjust the clamping position. This means that the control units 20 are movable up or down relative to the body 10 and the clamping position is able can be adjusted steplessly. This is the main benefit of the present invention. The holes 212 are cone-shaped holes so that when the control members 21 are moved, the engaging members 23 move outward along the tapered surface of the holes 212 and are separated from the outer surface of the body 10.

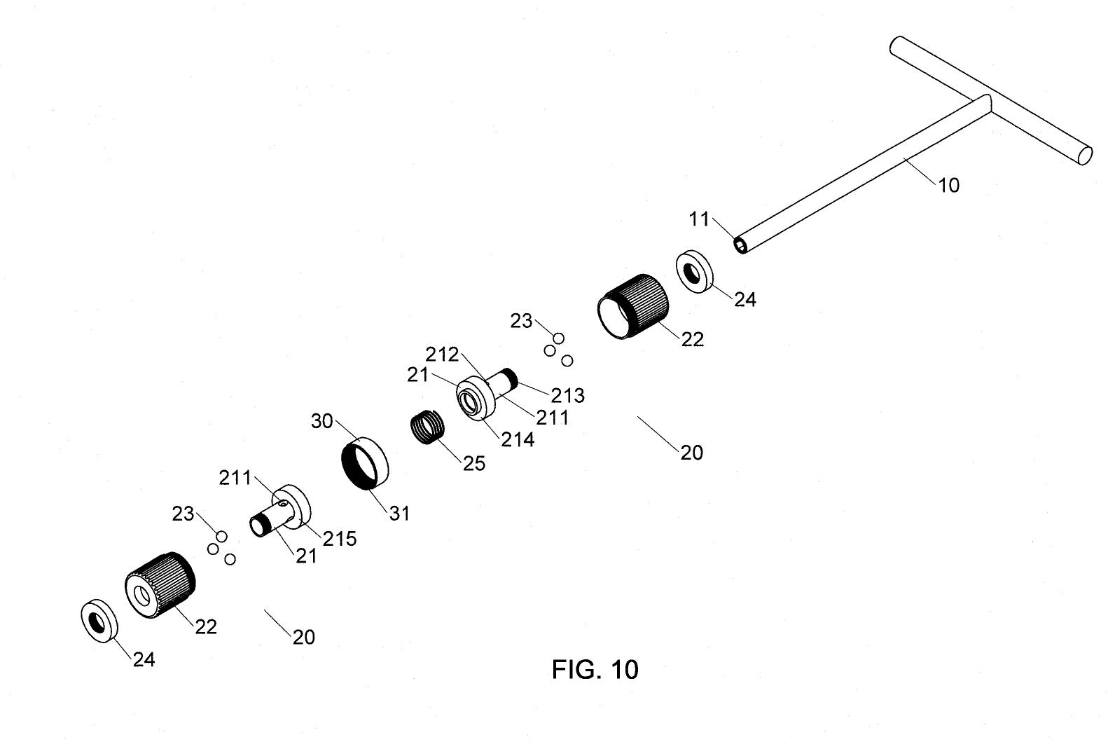

As shown in FIG. 8, the second embodiment shows that the engaging portion 11 of the body 10 is a rectangular end for being connected with socket, extension rod, or universal connector.

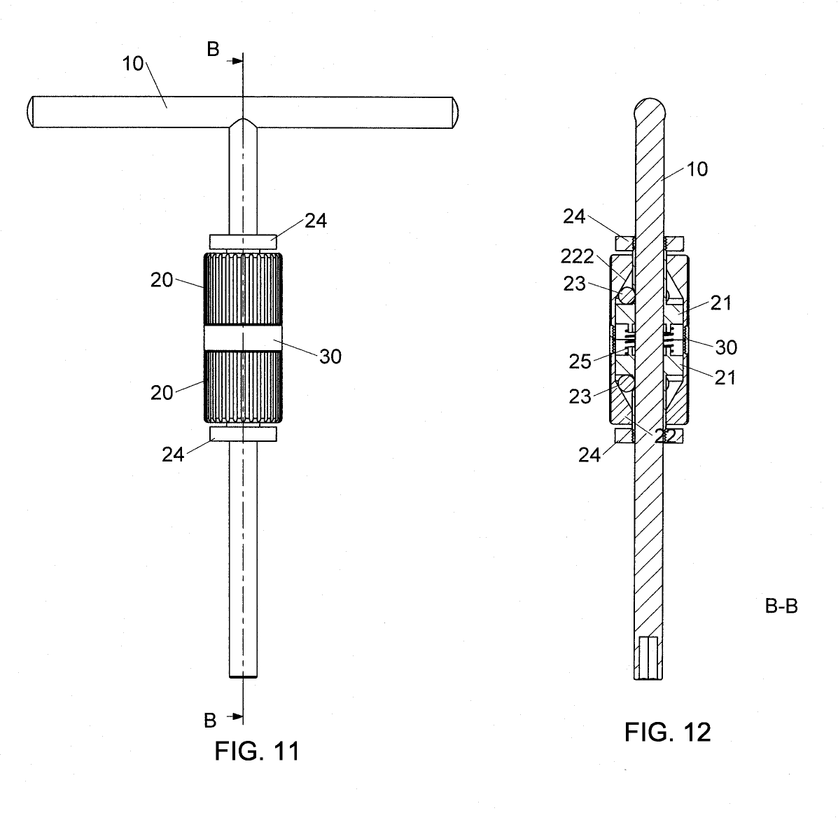

As shown in FIG. 9, the third embodiment shows that body 10 is a elongate rod and the engaging portion 11 is a rectangular end and the other end has a rectangular recess which is able to be connected with other tools with rectangular connection end.

The engaging members 23 are compressed by the cone-shaped passages 222 of the sleeves 22 and the flanges 215 of the control members 21 so that the engaging members 23 contact against the outer surface of the body 10 to restrict the body 10 from being movable within the two control units 20 so that the body 10 is positioned.

The engaging members 23 are compressed by the cone-shaped passages 222 of the sleeves 22 and the flanges 215 of the control members 21, by the two compressing forces, the engaging members 23 apply a vertical force to the outer surface of the body 10 to firmly position the body 10.

When pressing the connection ring 24 of one of the two control units 20, the two control units 20 are moved along the direction that the connection ring 24 is pressed to adjust the clamping position. The body 10 is still controlled by the other one of the two control units 20 and cannot move in the opposite direction. When compressing the two connection rings 24 of the two control units 20, all of the engaging members 23 are separated from the outer surface of the body 10 and the two control units 20 are freely movable along the body 10 to adjust the clamping position. This means that the control units 20 are movable up or down relative to the body 10 and the clamping position is able can be adjusted steplessly.

When operating the hand tool, the hand holes the two sleeves 22 and the body 10 is rotated 360 degrees, the body 10 is rotatable quickly within the two control units 20. There will be no friction between the body 10 and the hand.

The holes 212 are cone-shaped so that when the control members 21 are moved, the engaging members 23 are moved outward along the cone-shaped surface and approach the cone-shaped passages 222. The engaging members 23 are then separated from the outer surface of the body 10.

While we have shown and described the embodiment in accordance with the present invention, it should be clear to those skilled in the art that further embodiments may be made without departing from the scope of the present invention.

What is claimed is:

1. A hand tool comprising:
a body having an engaging portion defined in an end thereof, the engaging portion having a polygonal recess;
two control units respectively connected to the body and each control unit having a control member, a sleeve, multiple engaging members, a connection ring and a resilient member, the control member being a tubular member and rotatably mounted to the body, a control portion extending from a first end of the control member and having multiple holes defined annularly therein, each hole having a cone-shaped inner periphery and expanding outward, the control portion having a first connection portion at one end thereof and the first connection portion having outer threads, a flange extending between the control member and the control portion, the flange located close to the holes, the sleeve being a tubular member and having a through bore, a cone-shaped passage, a reception portion and a second connection portion, the through bore defined in a first end of the sleeve, the cone-shaped passage communicated between the through bore and the reception portion, the reception portion being a circular recess and the control member being received in the reception portion, the cone-shaped passage facing the flange, the control portion extending through the through bore, the first connection portion extending beyond the sleeve, a smallest inner diameter of the cone-shaped passage being the same as an inner diameter of the through bore, a largest inner diameter of the cone-shaped passage being the same as an inner diameter of the reception portion, the second connection portion located remote from the through bore and engaged with a second end of the sleeve, the second connection portion having inner threads, each engaging member being a bead and a number of the engaging members being the same as that of the holes, the engaging members being in contact between the flanges and the cone-shaped passage, each engaging member received in one of the holes corresponding thereto, a smallest inner diameter of the holes being less than a diameter of the engaging members, the connection ring having inner threads and mounted to the sleeve and threadedly connected to the first connection portion, a gap defined between the sleeve and the connection ring, the resilient member located in the reception portion, and
a connection member located between the two control units and mounted to the body, the connection member having two third connection portions respectively located on two ends thereof and each of the two third connection portions having outer threads, the two third connection portions connected to the second connection portions to connect the two control units to the connection member, the resilient member biased between the control member and the connection member, the engaging member being restricted between the cone-shaped passage and the flange and received in the hole, the engaging member contacting against an outer surface of the body.

2. The hand tool as claimed in claim 1, wherein the control member has a first end portion located at a second end thereof and the resilient member has one end mounted to the first end portion and contacts against the control member.

3. The hand tool as claimed in claim 1, wherein the connection member has two second end portions on two ends thereof and a diameter of each second end portion is smaller than that of the third connection portion, a shoulder portion is defined between the second end portion and the third connection portion, the resilient member has an end contacting against the second end portion.
